(19) United States
(12) Patent Application Publication
(10) Pub. No.: US 2006/0186973 A1
(43) Pub. Date: Aug. 24, 2006

(54) Radio frequency integrated circuit having a physical layer portion integrated therein

(75) Inventor: Shigeyuki Satou, Miyazaki-gun (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/324,757

(22) Filed: Jan. 4, 2006

(30) Foreign Application Priority Data
Jan. 5, 2005 (JP) 2005-000904

(51) Int. Cl. H01P 1/00; H01P 5/00

(52) U.S. Cl. 333/260

(57) ABSTRACT

A ZigBee-compliant radio frequency LSI includes a physical layer portion and a modulator. The physical layer portion has an RF portion, a demodulator, a data transmission and reception control, and a transfer mode determination portion. The transmission and reception control converts, during reception, symbol data received by the demodulator into the byte data received, and outputs, during transmission, the symbol data to be transmitted to the modulator. The determination portion determines, when the first identification data in the received data from the RF portion necessary for determining the received data transfer mode are fixed, the data length of the subsequent second identification data. The determination portion latches, when data corresponding to the determined length of the second identification data are fixed, the data necessary for determining the received data transfer mode to transfer the data to the MAC layer.

### BACKGROUND OF THE INVENTION

1. Field of the Invention

The present invention relates to a radio frequency integrated circuit, and more specifically to a radio frequency large-scale integrated circuit (LSI) which has its physical-layer interface compliant with IEEE (Institute of Electrical and Electronics Engineers) 802.15.4 and which is based upon ZigBee (trademark of ZigBee Alliance) technology. The invention more particularly relates to the control of receiving data in the radio frequency integrated circuit.

2. Description of the Background Art

ZigBee is one of the short-range radio frequency communication standards and classified into the radio frequency communication standard which uses sixteen channels into which divided is the same frequency bandwidth of 24 GHz as the wireless local area network (LAN) standard, IEEE 802.11b.

Conventional radio frequency integrated circuits, sometimes simply referred to as “radio frequency LSIs”, using ZigBee technology are disclosed in, for example, S. Fukunaga, et al., “Development of a Ubiquitous Sensor Network”, and T. Ichikawa, et al., “ZigBee LSI Implementing a Next Generation Short-Range Wireless Network”, Oki Technical Review, published by Oki Electric Industry Co., Ltd., Japan, Oct. 1, 2004, Vol. 71, No. 4, pp. 24-29, and 70-73, respectively.

As a communication layer model, the protocol configuration of ZigBee for use in the short-range radio frequency communication includes from lower to higher, for example, a physical layer and a data link layer of the international standard IEEE 802.15.4 for WL-PAN (Wireless Personal Area Network), over which are standardized a network layer, a transport layer, a session layer, a presentation layer and an application layer.

The physical layer has a data transmitting and receiving function such as a received-power measurement, a link-quality notification and the CSMA-CA (Carrier Sense Multiple Access with Collision Avoidance) which checks the channel usage. When setting up a network, the physical layer can measure the received power on respective channels to locate a channel which has its power least interfered with from other systems. Also provided is a mechanism for changing the communication channel when the channel being used is degraded in quality. The physical layer is specified as having, for example, a frequency of 2.4 GHz on sixteen channels with a modulation scheme of O-QPSK (Quadrature Phase Shift Keying) and a diffusion scheme of DSSS (Direct Sequence Spread Spectrum) at a data rate of 250 kbit/s, and is available all around the world.

The data link layer has a Media Access Control (MAC) layer which is a data-format process layer. The network layer manages the data transfer between two nodes connected on the network. The transport layer manages the communication. The session layer performs management from the start to the end of the communication. The presentation layer manages the interface between the application and session layers.

The MAC layer in the data link layer defines a beacon mode for the intermittent operation and the bandwidth assurance communication, and a non-beacon mode for the direct communication between all nodes. The beacon mode is for use in the star type network which centers on a network management node referred to as a PAN (Personal Area Network) coordinator. The PAN coordinator periodically transmits a beacon signal. Synchronously with the beacon signal, other nodes communicate within the allocated period. Only one of the nodes which is allocated by the coordinator can occupy the channel to communicate without confliction. The beacon mode is thus used in the communication which requires a lower delay. The non-beacon mode is a mode in which a continuous channel access is performed in CSMA-CA. If the non-beacon mode is used in a mesh type of link which directly communicates with nodes therearound, the nodes can always directly communicate with each other. Every node, however, has to be always on standby so that they can receive a data addressed to them. The non-beacon mode thus cannot save power with the intermittent operation unlike the beacon mode.

When the non-beacon mode is used in a star type of link, only a base station is rendered operative to be ready to receive signals and end devices intermittently stop and wait to thereby save power on the end devices. In this method, the end devices periodically send out requests to the base station before receiving the downstream data, thereby causing a transmission delay in the downstream communication. It is, however, possible with the CSMA-CA to establishing a constant upstream communication from the end devices which is the predominant data flow on the sensor network.

The ZigBee network in the network layer has a cluster-tree structure which integrates the star-type topology with the mesh-type topology regulated under the IEEE 802.15.4. The ZigBee network includes a ZigBee coordinator, ZigBee routers and ZigBee end devices. The coordinator and routers implement a PAN coordinator function and form a star link or cluster. Between the coordinator and the routers, a mesh link is formed to provide a multihop network.

End devices are connected to the coordinator or routers by the star link to participate in the network. The end devices communicate in a multihop fashion via a router to which the end device 13 is connected to communicate with other end devices connected to the network.

The transmitting and receiving data format for use in the physical layer includes the fields, Preamble Sequence which is a signal for synchronization, Start of Frame Delimiter which is a transfer-start signal, Frame Length representing a data length in bytes from the field Frame Control to the field FCS (Frame Check Sequence), where one byte includes eight bits. The field, Frame Control, is a signal defining the data type. The data type includes the frame type of representing Beacon, Data, Acknowledgement or Command, an address type of a source and a destination in a 16-bit mode and a transfer mode representing a security mode or a through mode. The field, Sequence Number, include3s an identification signal representative of a sequence number during transfer. The field, Addressing Field, includes the address of a source or destination. The field, Addressing Field, is variable from zero byte to 21 bytes, depending on the value of the field, Frame Control. The field, Data Payload, is representative of a transferable data amount from zero to 122 bytes. The field, FCS, includes a data check, e.g. frame check sequence, signal. The data are transmitted and received in the data format as described above.

Radio frequency LSIs for ZigBee are specified differently depending on functional blocks implementing the physical layer, data link layer and network layer. For example, the articles authored by S. Fukunaga, et al., and T. Ichikawa, et al., stated earlier teach, by contrast to a technology which integrates on a single semiconductor chip only a radio frequency transmitter and receiver, sometimes referred to as “RF portion”, and a physical layer portion to provide a radio frequency LSI, the RF portion including an analog radio frequency circuit for transmitting and receiving data with a radio frequency (RF) signal, with the MAC layer implemented by software, or program sequence, running on a host central processing unit (CPU), a technology which integrates on one semiconductor chip an RF portion, a physical layer portion, and a MAC layer portion to provide a radio frequency LSI fully compliant with IEEE 802.15.4, wherein a complicated MAC process is implemented by the radio frequency LSI and a ZigBee network can be implemented and controlled with a host processor with lower performance, such as 8-bit processor.

In either of such radio frequency LSIs, the physical layer controls the transmission and reception of the data, and the data link layer analyzes the transmitted and received data to determine the transfer in the through mode or in the security mode. In the security mode, the data link layer performs encryption/decryption before passing the data to the next layer. The network layer transmits and receives the data to and from the host processor using a serial circuit or the like.

In ZigBee transmission, when the RF portion receives an RF signal carrying data, a demodulator demodulates the signal into symbols conveying a message. The received data have the data length thereof up to 133 bytes. Specifically, the frame, Frame Length, defines a data length up to 127 bytes. Up to the data length of 127 bytes in total, each field can have any number of bytes, so that the data length of up to 133 bytes may be calculated in the following manner that four, one, one and 127 bytes of fields, Preamble Sequence, Start of Frame Delimiter, Frame Length, Frame Control and FCS, respectively, the total being 133 bytes.

The physical layer then temporarily holds the received data of up to 133 bytes for passing the data to the data link layer following thereto. The physical layer converts the symbol data into byte data. One symbol is received for 16 microseconds, and two symbols form one-byte data. After receiving all the data, the data link layer determines the transfer mode and starts sucking the data. The transfer mode for the received data is determined depending on the values of the fields, Frame Control and Addressing Field. Generally, that determination is made by the MAC layer. The processed data are then passed, or transferred (in the through mode/security mode) to the network layer. The network layer transmits, or transfers, the data to the host processor.

Where a radio frequency LSI contains the function of a MAC layer associated with a data link layer as its functional block, the radio frequency LSI can perform thereinside all of a series of processing received data. However, where the function of a MAC layer is provided in a host processor positioned outside a radio frequency LSI, the radio frequency LSI temporarily holds the received data thereinside, waiting for determination made by the MAC layer provided outside. The network layer in turn transmits, or transfers, the data, such as Frame Control and Addressing Field, necessary for determining the transfer mode to the outside MAC layer. The MAC layer determines the transfer mode, through mode/security mode, and thereafter the MAC layer notifies the inside of the radio frequency LSI of the result from the transfer mode determination to restart the transfer.

The above-described conventional radio frequency LSI, however, suffers from the following problems. For a MAC layer function that is provided outside a radio frequency LSI, the data transfer rate of devices in a network layer is set by a user's request. It is therefore possible that the transfer rate is extremely lowered. Furthermore, since the system is structured such that entire data of up to 133 bytes are received by a physical layer and thereafter data necessary for transfer retransmitted to the outside MAC layer, it may be belated that the MAC layer determines the transfer, thereby causing the radio frequency communication system to be deteriorated in specifications, or performance.

Additionally, even for a MAC layer function that is provided inside a radio frequency LSI, it is required to decrease the burden on the MAC layer, and to notify more rapidly the MAC layer of information on the Addressing Fields, thereby improving the performance of a series of data transfer processes.

### SUMMARY OF THE INVENTION

It is an object of the present invention to provide a radio frequency integrated circuit capable of allotting more time to providing the MAC layer of ZigBee with information data for determining a transfer mode and to determining the transfer mode by the MAC layer, thereby satisfying much more requests from users.

In accordance with the present invention, a radio frequency LSI for transmitting or receiving data over a radio wave according to a radio frequency communication standard, such as ZigBee, regulating a physical layer which controls transmission or reception of data, a data link layer including a MAC layer which analyzes data to be transmitted or data received and controlled by the physical layer to determine a transfer mode and which uses the transfer mode determined to process the data to be transmitted or data received to transfer the processed data to a next layer, and a network layer which manages a transfer of the data to be transmitted and data received and transferred from the data link layer. The radio frequency LSI comprises an RF portion, a demodulator, a physical layer portion comprising a data transmission and reception control, and a transfer mode determination portion, and a modulator.

The RF portion receives during reception, an incoming radio wave to output the received data, and converts, during transmission, the data to be transmitted into an outgoing radio wave to transmit the outgoing radio wave. The demodulator demodulates the received data into a symbol to output symbol data received.

The data transmission and reception control in the physical layer portion converts, during reception, the symbol data received into byte data received, and outputs, during transmission, symbol data to be transmitted. The transfer mode determination portion included in the physical layer portion determines, at a first time point at which first identification data in the received data necessary for determining a received data transfer mode are fixed, a data length of subsequent second identification data, and latches, at a second time point at which data corresponding to the data length determined of the second identification data are fixed, data necessary for determining the received data transfer mode to transfer the data to the MAC layer. The modulator modulates the symbol data to be transmitted into the data to be transmitted to output the data to be transmitted to the RF portion.

According to an aspect of the present invention, at the time point at which the data necessary for determining the received data transfer mode are fixed in the physical layer portion, the physical layer portion latches the data and notifies the MAC layer, so that, during receiving subsequent data, the network layer can transfer the data and the MAC layer can determine the transfer mode. This can provide more time for the transmission of information for the transfer mode determination to the MAC layer and for the transfer mode determination by the MAC layer, thereby allowing more requirements from users to be satisfied.

According to another aspect of the invention, the radio frequency LSI comprises the MAC layer, so that the radio frequency LSI can perform the complicated MAC process thereinside, thereby making it possible to implement and control the ZigBee network with a host processor with lower performance, such as an 8-bit processor. Furthermore, the radio frequency LSI with the built-in MAC layer comprises the physical layer portion, and, at the second time point at which data necessary for determining the received data transfer mode are fixed in the physical layer portion, the physical layer portion latches the data and notifies the MAC layer, so that the MAC layer burden can be decreased and the MAC layer can be notified more rapidly of information on the field, Addressing Field, for example, thereby improving the performance of the series of data transfer process.

### BRIEF DESCRIPTION OF THE DRAWINGS

The objects and features of the present invention will become more apparent from consideration of the following detailed description taken in conjunction with the accompanying drawings in which:

FIG. 1 is a schematic functional block diagram showing a radio frequency LSI of an embodiment according to the present invention;

FIG. 2 schematically shows the format of received data in the physical layer portion shown in FIG. 1;

FIG. 3 schematically shows a detail of the MAC header shown in FIG. 2;

FIG. 4 exemplarily shows a result from analyzing data of the field, Frame Control, shown in FIG. 2;

FIG. 5A shows the conventional state of received data;

FIG. 5B shows the state of received data according to the illustrative embodiment shown in FIG. 1;

FIG. 6 is a schematic function block diagram, like FIG. 1, of the radio frequency LSI of an alternative embodiment according to the present invention;

FIG. 7 shows a communication layer model of the protocol configuration of ZigBee;

FIG. 8 exemplarily shows a network model of ZigBee;

FIG. 9 shows a general flow of processing received data during reception in the hierarchy shown in FIG. 7; and

FIG. 10 exemplarily shows a process flow when the MAC layer shown in FIG. 7 is provided in a host processor outside a radio frequency LSI.

### DESCRIPTION OF THE PREFERRED EMBODIMENTS

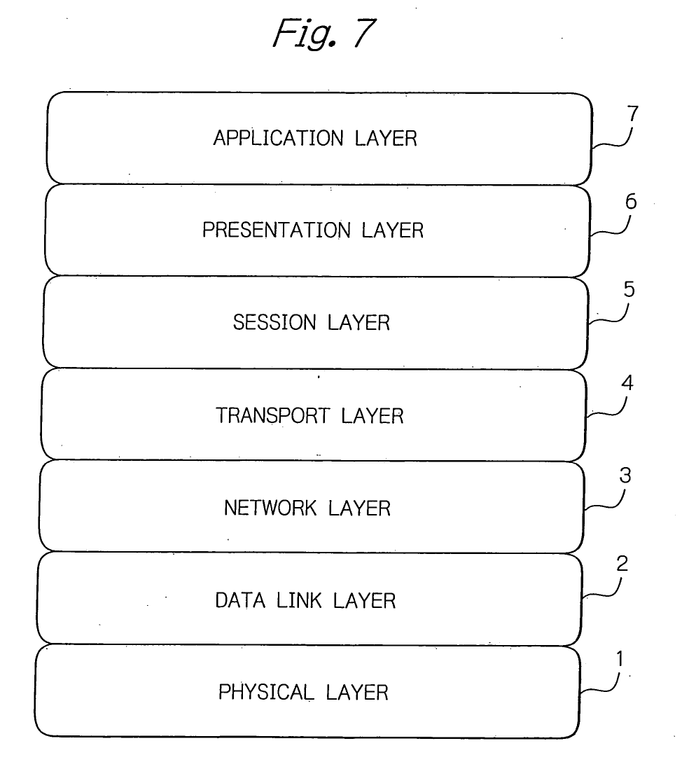

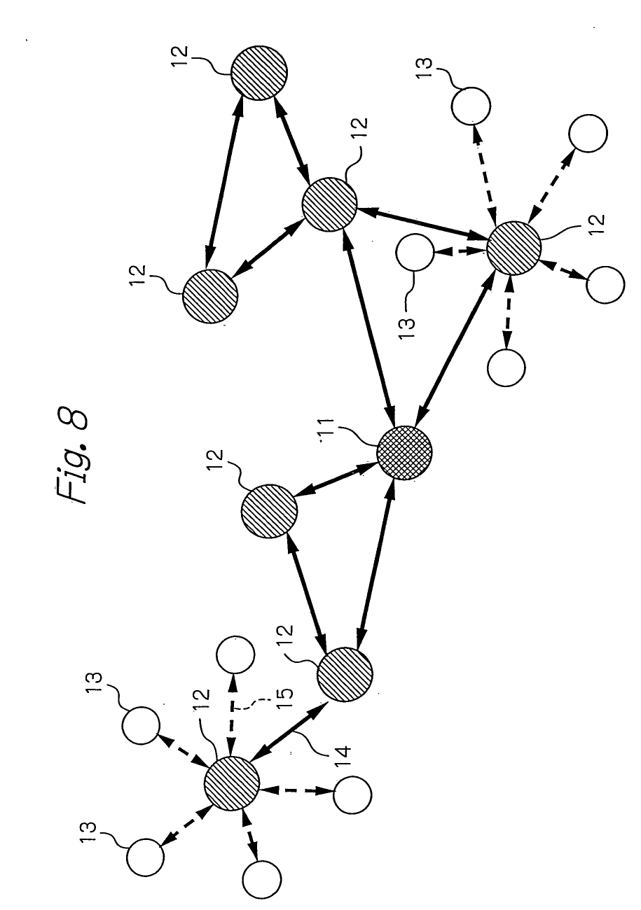

At first, reference will be made to FIG. 7 showing a communication layer model of a protocol configuration of ZigBee for use in the short-range radio frequency communication, and to FIG. 8 showing a network model of ZigBee. The protocol configuration of ZigBee includes, for example, a physical layer 1 and a data link layer 2 under the international standard IEEE 802.15.4 for WL-PAN (Wireless Personal Area Network). Thereover, a network layer 3, a transport layer 4, a session layer 5, a presentation layer 6, and an application layer 7 are positioned in this order from the lower.

The ZigBee network in the network layer 3 has a cluster tree structure which integrates the star type topology with the mesh type topology under IEEE 802.15.4. In the model of a ZigBee network shown in FIG. 8, there is a single ZigBee coordinator 11. ZigBee routers 12 form a mesh type of network, as depicted with fat arrows 14. The ZigBee routers 12 have ZigBee end devices 13 interconnected to form a star type of links, or cluster, as shown with dotted fat arrows 15 in the figure. The coordinator 11 and routers 12 thus establish a PAN (Personal Area Network) coordinator function as stated earlier. The coordinator 11, routers 12, and mesh link 14 can provide a multihop network.

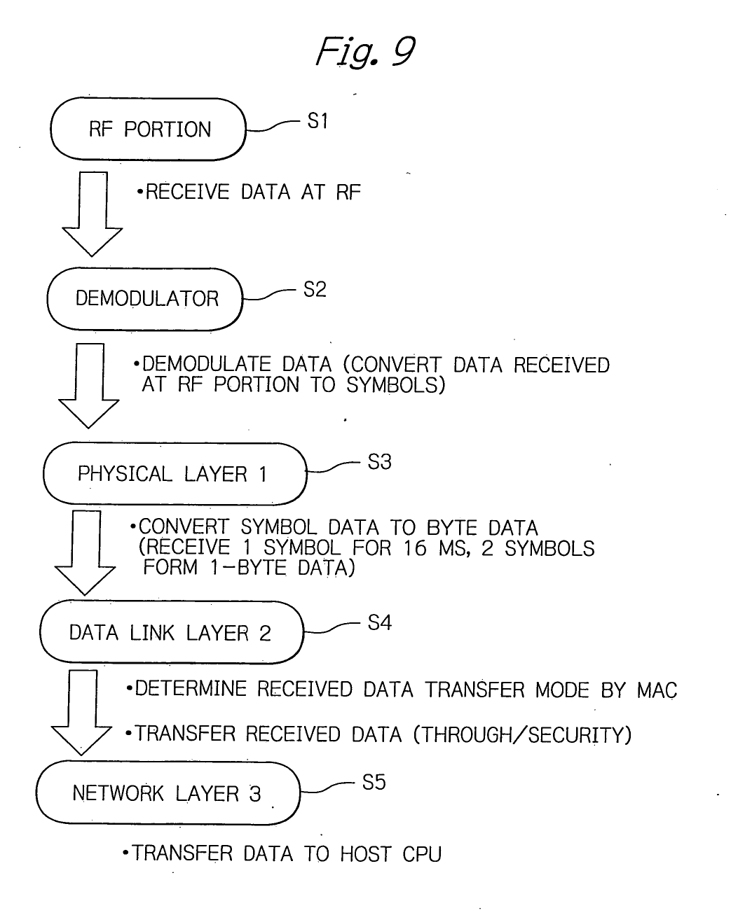

For the purpose of better understanding the invention, it will be described how received data are processed during reception in the hierarchy shown in FIG. 7. With reference to FIG. 9, in the step S1, an RF portion receives an RF signal including data. Then, in the step S2, a demodulator demodulates the received data into symbols or a message.

In the step S3, the physical layer 1 temporarily holds the received data of up to 133 bytes for passing the data to the next data link layer 2. The physical layer 1 converts the symbol data into byte data. In the step S4, after having received the entire data, the data link layer 2 determines the transfer mode and starts sucking the data. The received data transfer mode is determined depending on the values of the fields, Frame Control, and, Addressing Field. Generally, the MAC layer determines the transfer mode. The MAC layer then transfers in the through mode/security mode the processed data to the network layer 3. In the step S5, the network layer 3 transmits or transfers the data to a host processor.

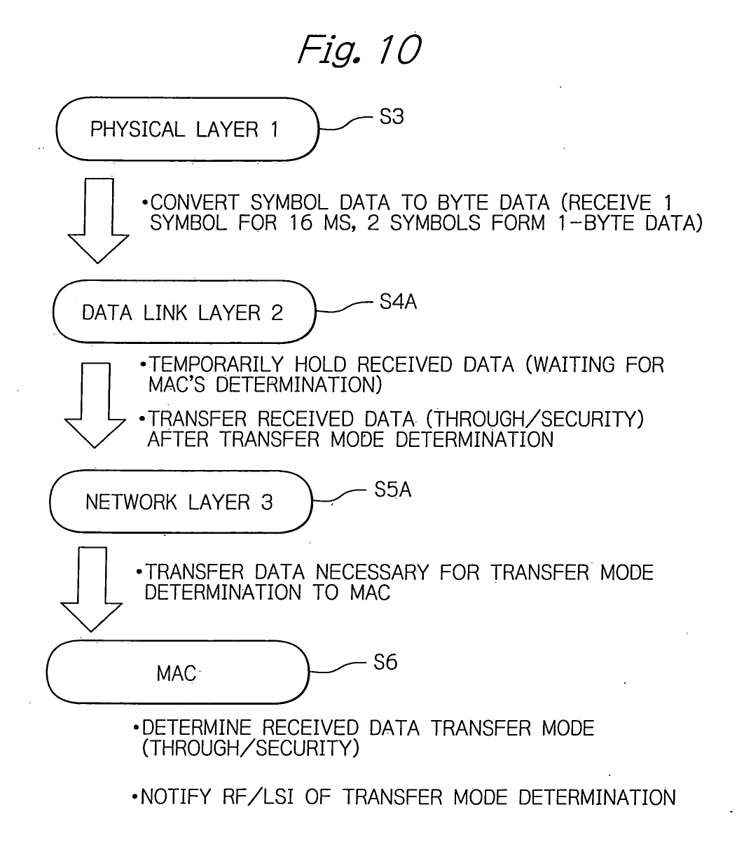

FIG. 10 shows the process flow when the MAC layer in the hierarchy shown in FIG. 7 is provided in a host processor provided outside a radio frequency LSI. When a radio frequency LSI contains the MAC layer thereinside as a functional block of the radio frequency LSI, the radio frequency LSI can perform thereinside all of a series of processes of the received data, as shown in FIG. 9. When the MAC layer function associated with the data link layer 2 in FIG. 9 is provided in a host processor provided outside the radio frequency LSI, however, in the step S4A, the radio frequency LSI temporarily holds therein the received data, waiting for determination made by the outside MAC layer, as shown in FIG. 10. In the step S5A, the network layer 3 transmits or transfers to the outside MAC layer the data, such as Frame Control and Addressing Field, necessary for determining the transfer mode. In the step S6, the MAC layer determines the transfer mode, through mode or security mode, and thereafter the MAC layer notifies the inside of the radio frequency LSI of the transfer mode determination to restart the transfer.

Basically, in preferred embodiments of the present invention, a radio frequency LSI is adapted to transmit and receive data on a short-range radio wave prescribed under ZigBee, and comprises a radio frequency (RF) portion, a demodulator, a physical layer portion comprising a data transmission and reception control and a transfer mode determination portion, and a modulator.

More specifically, the RF portion has its receiver adapted to receive an incoming short-range radio wave to output received data, and its transmitter adapted to convert data to be transmitted to a short-range radio wave to transmit the latter. The demodulator demodulates the received data into symbols to output symbol data received. The data transmission and reception control in the physical layer portion, in its receiving operation, converts the symbol data received into byte data received, and in its transmitting operation, outputs symbol data to be transmitted. The transfer mode determination portion in the physical layer portion determines, at the first time point at which the first identification data in the received data necessary for determining a received data transfer mode are established, the data length of subsequent second identification data. The transfer mode determination portion latches, at the second time point at which data corresponding to the length of the second identification data thus determined are established, latches data necessary for determining the received data transfer mode to transfer the data thus latched to the MAC layer. The modulator modulates symbol data to be transmitted into the transmission data to output the transmission data to the RF portion.

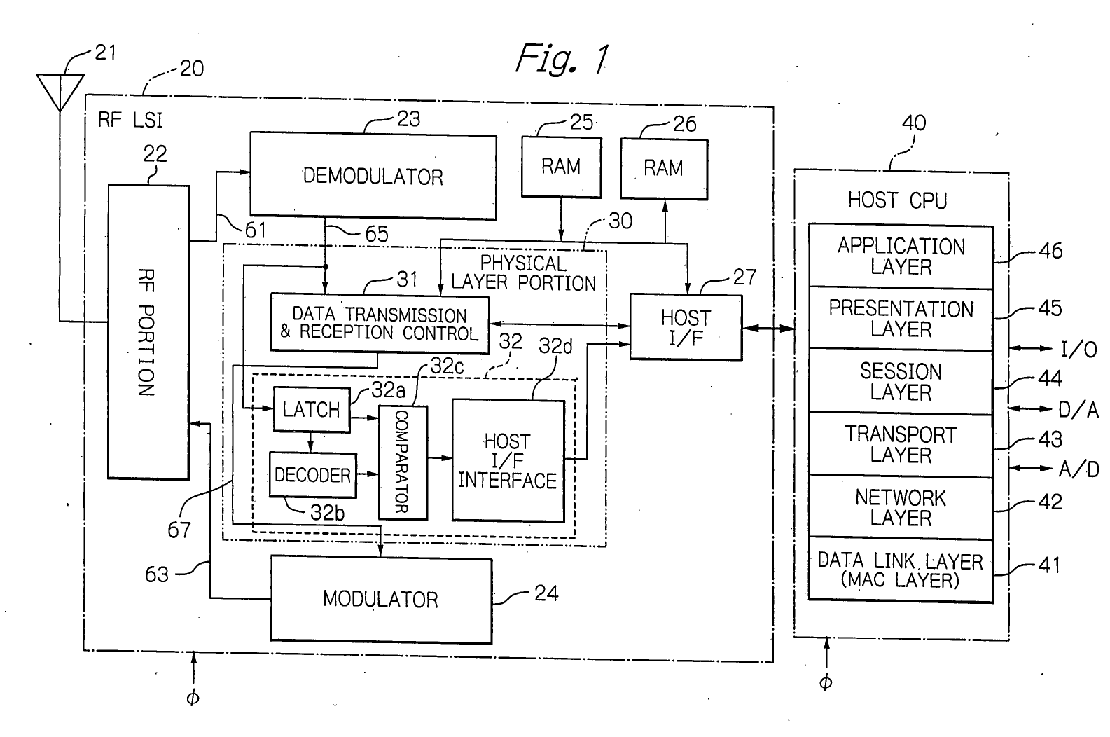

Now, with reference to FIG. 1, a preferred embodiment of a radio frequency LSI will be described according to the present invention. The radio frequency LSI 20 of the illustrative embodiment is adapted to comply with ZigBee, which is one of the short-range radio frequency communication standards. The radio frequency LSI 20 comprises an RF portion 22 connected to an antenna 21, a demodulator 23, a modulator 24, a two-plane random access memory (RAM) 25 for storing data, a RAM 26 for storing working data, a host interface (I/F) 27, and a physical layer portion 30 or the like, all of which are interconnected as illustrated and integrated in a semiconductor chip. The radio frequency LSI 20 is adapted to cause the MAC layer to function on a host central processor unit (CPU) 40 controlled by program sequences.

Specifically, the radio frequency LSI 20 is adapted to operate in response to a clock signal ∅ provided from an oscillator or the like, not shown, and is provided with the RF portion 22 therewithin. The RF portion 22 is compliant with IEEE 802.15.4. The RF portion 22 comprises a transmitter and receiver circuit including an analog circuit, although not specifically shown, for transmitting and receiving a radio frequency signal of 2.4 GHz to and from the antenna 21. The RF portion 22 has its output port 61 connected to the demodulator 23 and its input port 63 connected to the modulator 24.

The demodulator 23 is compliant with IEEE 802.15.4. The demodulator 23 is adapted to take in the received data 61 from the RF portion 22 via its intermediate frequency (IF) interface, not shown, and demodulate the received data 61 to output the demodulated data 65. In the following, signals are designated with reference numerals on connections on which they are conveyed. The demodulator 23 has its output port 65 connected to the physical layer portion 30. The modulator 24 is compliant with IEEE 802.15.4. The modulator 24 is adapted to modulate modulation data inputted in the form of IQ data into a modulated signal to output the modulated signal 63 to the RF portion 22. The modulator 24 has its input port 67 connected to the physical layer portion 30.

The physical layer portion 30 is also compliant with the IEEE 802.15.4 physical layer. The physical layer portion 30 comprises, for example, a two-plane RAM 25 having its storage planes, each of which has storage locations of 128 bytes for storing data to be transmitted and data received. The physical layer portion 30 is adapted to, in its receiving operation, take in the demodulated data 65 from the demodulator 23, and in its transmission operation, output the modulation data 67 to the modulator 24 in the form of IQ data. Also connected to the physical layer portion 30 are, for example, a RAM 26 of 6 Kbit for storing working data and a host interface 27. The host interface 27 functions an interface through which a signal is transferred between the physical layer portion 30 and the host CPU 40 arranged outside.

The physical layer portion 30 comprises, as with a conventional physical layer function, a data transmission and reception control 31 including a data transmission and reception control function such as a received power measurement, a link quality notification and the CSMA-CA (Carrier Sense Multiple Access with Collision Avoidance) which checks the channel usage. As in the conventional one, the data transmission and reception control 31 is specified as having, for example, a frequency of 2.4 GHz on sixteen channels with a modulation scheme of O-QPSK (Quadrature Phase Shift Keying) and a diffusion scheme of DSSS (Direct Sequence Spread Spectrum) at a data rate of 250 kbit/s, and is adapted to be available all around the world.

The illustrative embodiment is specific to the physical layer portion 30 which additionally comprises therein the transfer mode determination portion 32, which is adapted to latch data, such as Frame Control and Addressing Field, necessary for determining the transfer mode, through mode of security mode, and transmit the data to the MAC layer, which were conventionally performed by the data link layer. The transfer mode determination portion 32 comprises, for example, a latch 32a adapted for latching the data of the fields, Frame Control and Addressing Field, of the demodulated data from the demodulator 23, a decoder 32b for decoding or analyzing the value of the field, Frame Control, latched by the latch 32a, a comparator 32c for comparing the value of the field, Addressing Field, latched by the latch 32a with the result from the decoding to determine the data length of the field, Addressing Field to thereby determine whether to notify the host CPU 40 of the result from the comparison, and a host I/F interface 32d which transfers the determination result of the comparator 32c to the host interface 27. Those constituent elements are interconnected as illustrated in FIG. 1.

The host CPU 40 operates also in response to the clock signal ∅ provided from an oscillator or the like, not specifically illustrated. The host CPU 40 functions as a data link layer 41 having an IEEE 802.15.4 MAC layer, a network layer 42, a transport layer 43, a session management layer or session layer 44, a presentation layer 45, and an application layer 46. The host CPU 40 also has functions such as the input/output (I/O) of various signals, the digital-to-analog (D/A) conversion of a digital signal into a corresponding analog signal to outputting the resultant analog signal, and the analog-to-digital (A/D) conversion of a provided analog signal into a corresponding digital signal to input the resultant digital signal to the radio LSI 20.

The data link layer 41 has the MAC layer, which is the data format process layer. From the MAC layer, some of the functions of the MAC layer which were performed by the data link layer 41 are removed, such as the latch of the data necessary for determining the transfer mode (through mode/security mode) and the transmission of data to the MAC layer. Those removed functions are provided in the physical layer portion 30 in the wireless LAN 20. The remaining layers may be the same as the conventional ones. Specifically, the network layer 42 manages data transfer between two nodes connected on the network. The transport layer 43 manages the communication. The session layer 44 performs management from the start to the end of the communication. The presentation layer 45 manages the interface between the application layer 46 and session layer 44.

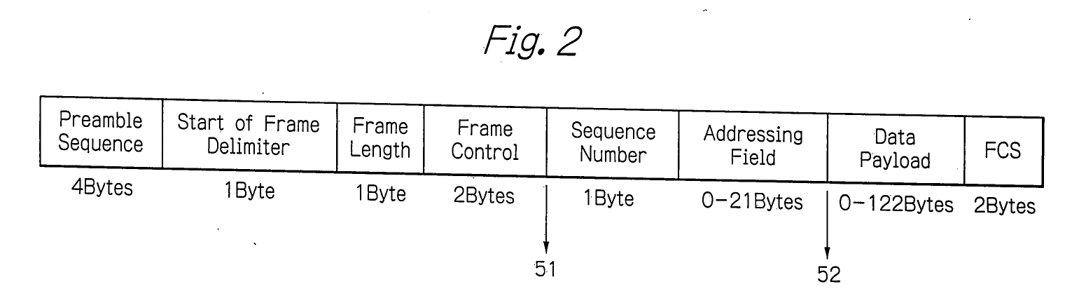

FIG. 2 shows the format of data received in the physical layer 30 shown in FIG. 1. Specifically, in the received data format shown in FIG. 2, the field, Preamble Sequence, stores therein a signal for synchronization, the field, Start of Frame Delimiter, stores therein a transfer start signal, the field, Frame Length, stores therein a data length represented in bytes from the field, Frame Control, to the field, FCS (Frame Check Sequence), where one byte corresponds to eight 8 bit. The field, Frame Control, is to store a signal representing the type of data. The type of data includes the frame type, such as Beacon, Data, Acknowledgement or Command, the address type of a source and a destination in the 16-bit mode, and a transfer mode in the security mode or through mode. The field, Sequence Number, is an identification signal, or sequence number, during transfer. The field, Addressing Field, stores therein the address of a source or a destination. The field, Addressing Field, is variable in length from 0 to 21 bytes, depending on the value of the field, Frame Control. The field, Data Payload, is representative of the amount of transferable data and takes the value of 0 byte to 122 bytes. The field, FCS, is to store therein a frame check sequence signal. Data are received in this data format shown in the physical layer portion 30.

In operation, the radio frequency LSI 20 and host CPU 40 shown in FIG. 1 transmit and receive data in the data format in FIG. 2, as described below. Data transmission and reception are controlled by the data transmission and reception control 31 in the physical layer portion 30. The data link layer 41 analyzes transmitted and received data to determine the transfer in the through mode or in the security mode. In the security mode, the data link layer 41 performs encryption/decryption before passing the data to the next network layer 42. The network layer 42 transmits and receives the data to and from the host CPU 40 by means of a serial circuit or the like.

A description will now be given to the process flow of the received data in the reception operation. When the RF portion 22 receives data in the form of RF signal from the antenna 21, the demodulator 23 demodulates the received data into symbols. Referring to FIG. 2, the received data has its data length up to 133 bytes. The data transmission and reception control 31 in the physical layer portion 30 temporarily holds the received data up to 133 bytes for passing the data to the data link layer 41 following thereto. The data transmission and reception control 31 converts the symbol data into the byte format of data as shown in FIG. 2. At the first time point 51, FIG. 2, at which the data of the field, Frame Control, necessary for determining the received data transfer mode is fixed or established in the physical layer portion 30, the value of the field, Frame Control, determines the data length of a field, Addressing Field, subsequent thereto, and the following steps will be performed.

The latch 32a latches the value of the field, Frame Control. The decoder 32b decodes or analyzes the latched value. The comparator 32c compares the result fro the decoding with the value of the field, Addressing Field, latched by the latch 32a, and determines the data length of the field, Addressing Field. The comparator 32c then passes the data length thus determined to the host interface 27 via the host I/F interface 32d.

At the second time point 52, FIG. 2, at which data corresponding to the fixed data length of the field, Addressing Field, are fixed or established, the data transmission and reception control 31 latches the data, such as Frame Control and Addressing Field, necessary for determining the received data transfer mode, and then transfers the data thus latched to the MAC layer in the data link layer 41, i.e. notifies the MAC layer in the data link layer 41 of the data, via the host interface 27.

After having received the entire data, the data link layer 41 determines the transfer mode and starts sucking the data. The sucked data are passed or transferred (in the throughmode/security mode) by the data link layer 41 to the network layer 42.

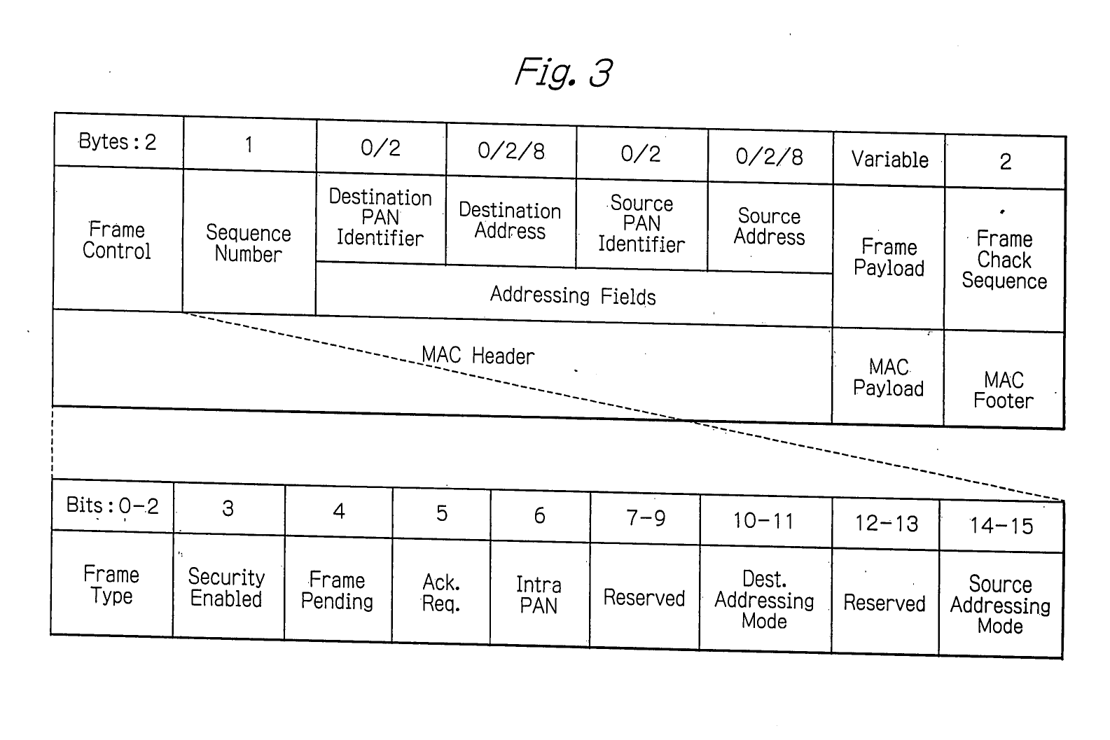

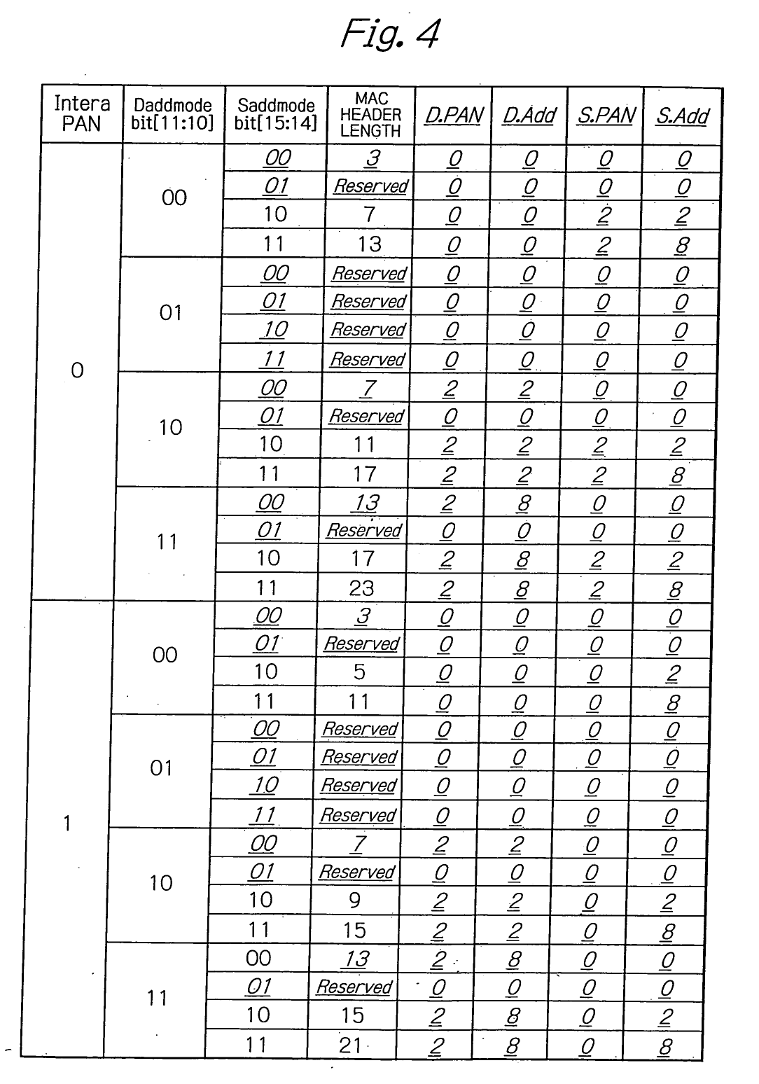

FIGS. 3 and 4 show how to determine the MAC header length of the MAC header and the data length of the field, Addressing Field. FIG. 3 is a detailed view showing the MAC header shown in FIG. 2 together with the MAC header length. FIG. 4 exemplarily shows data resultant from the analysis of the field, Frame Control, shown in FIG. 2.

A description will now be made on the method of determining the data length of the filed, Addressing Field, at the time point 51 shown in FIG. 2. As specifically shown in FIG. 3, the MAC header comprises the fields, Frame Control, of two bytes, Sequence Number, of one byte, and Addressing Field, of 0 to 20 bytes. The MAC header thus has a variable length of 3 to 23 bytes. Analysis on the field, Frame Control, of the first two bytes can provide knowledge of the MAC header length. Data required for the analysis are of five bits, comprising, among the sixteen bits forming the two bytes of the field, Frame Control, the one bit, IntraPAN, at the sixth bit position, the two bits, Destination addressing mode, hereinafter referred to as “Daddmode”, at the tenth to eleventh bit, and the two bits, Source addressing mode, hereinafter referred to as “Saddmode” at the fourteenth to fifteenth bit. FIG. 4 shows the MAC header lengths for the values taken by those five bits.

In FIG. 4, the columns “D.PAN” and “D.Add” show data associated with information on the destination of data, and the columns “S.PAN” and “S.Add” show data associated with information on the source of data. The data “D.PAN,” “D.Add,” “S.PAN,” and “S.Add” are variably set in dependent upon the setting of the three signals “IntraPAN”, “Daddmode”, and “Saddmode” shown in FIG. 3.

When the column “IntraPAN” contains a binary “1” and an address is set in the columns “Daddmode” and “Saddmode”, data are omitted from the bit positions, “Source PAN identifier (ID)” in the field, Addressing Field. When the column “IntraPAN” contains a binary “0” and an address is set in the bit positions “Daddmode” and “Saddmode”, data are set in both of the bit positions “Destination PAN identifier (PAN-ID)” and “Source PAN identifier (PAN-ID)” in the field, Addressing Field. In the bit positions “Daddmode” and “Saddmode”, a binary value “00” indicates that neither address nor PAN-ID exists, a binary value “01” indicates “Reserved”, a binary “10” represents the 16-bit address mode with a PAN-ID existing, and a binary value “11” represents the 64-bit address mode with a PAN-ID existing.

The physical layer can refer to the data “D.PAN” and “D.Add” including information on a destination to determine whether or not the data are addressed to the physical layer per se. The MAC layer can comprehensively analyze the information to determine its operation. In the illustrative embodiment, the latch 32a, decoder 32b, and comparator 32c analyze and compare the three signals “IntraPAN,” “DAddmde,” and “Saddmode” to determine the MAC header length and the data length of the field, Addressing Field.

For example, when the bit “IntraPAN” takes a binary value “1”, the bits “Daddmode” take a binary value “11”, and the bits “Saddmode” take a binary value “11”, the field, D.PAN, takes two bytes, the field, D.Add, takes eight bytes, the field, S.PAN, takes no byte, i.e. no PAN information on the source, and the field, S.Add, takes eight bytes, thus providing the field, Addressing Field, of 18 bytes in total. In this case, the source of the data is determined on the field, S.Add.

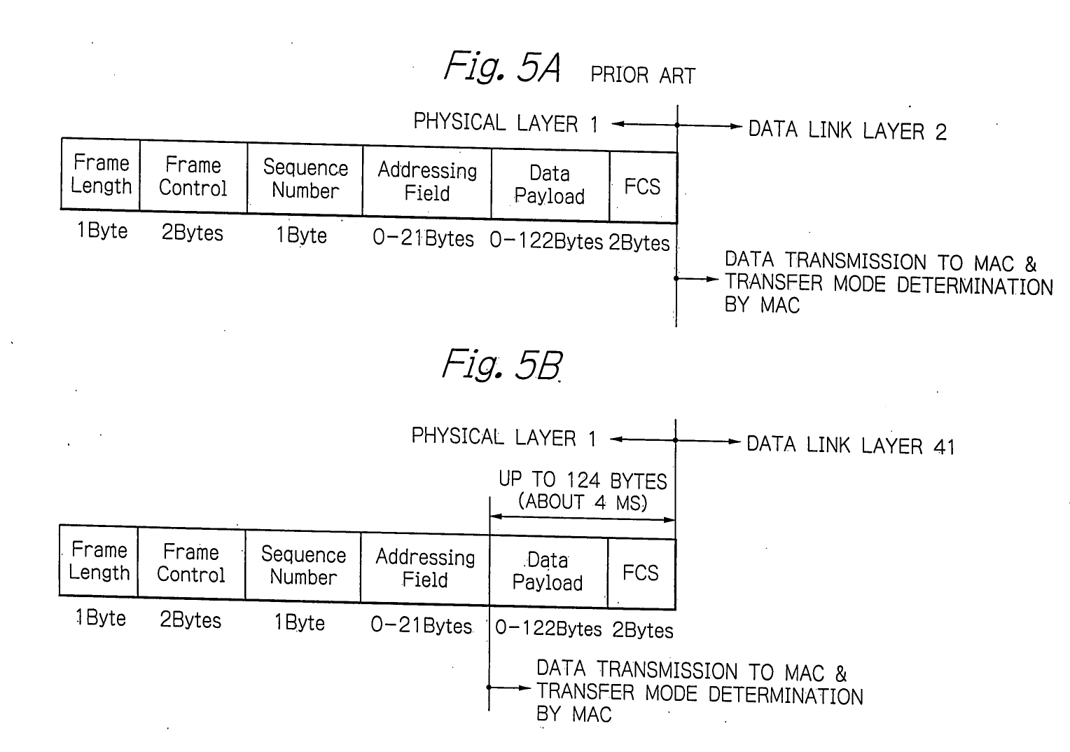

FIG. 5A shows the state of data received in a conventional technology. FIG. 5B the state of data received in the illustrative embodiment. In the illustrative embodiment, at the first time point 51, FIG. 2, at which data necessary for determining the received data transfer mode are fixed in the physical layer portion 30, the physical layer portion 30 latches the data and notifies the MAC layer. Therefore, as shown in FIG. 5B, during receiving the subsequent fields, Data Payload to FCS, the network layer 42 can transfer the data and the MAC can determine the transfer mode. Those fields takes 0 to 124 bytes, i.e. 0 to about four milliseconds where one byte is transferred in a period of 16 microseconds×2. This can provide more time, compared to the conventional receiving condition shown in FIG. 5A, for the transmission of information data for determining the transfer mode to the MAC layer and for the determination of the transfer mode by the MAC layer, thereby allowing more requirements from users to be satisfied.

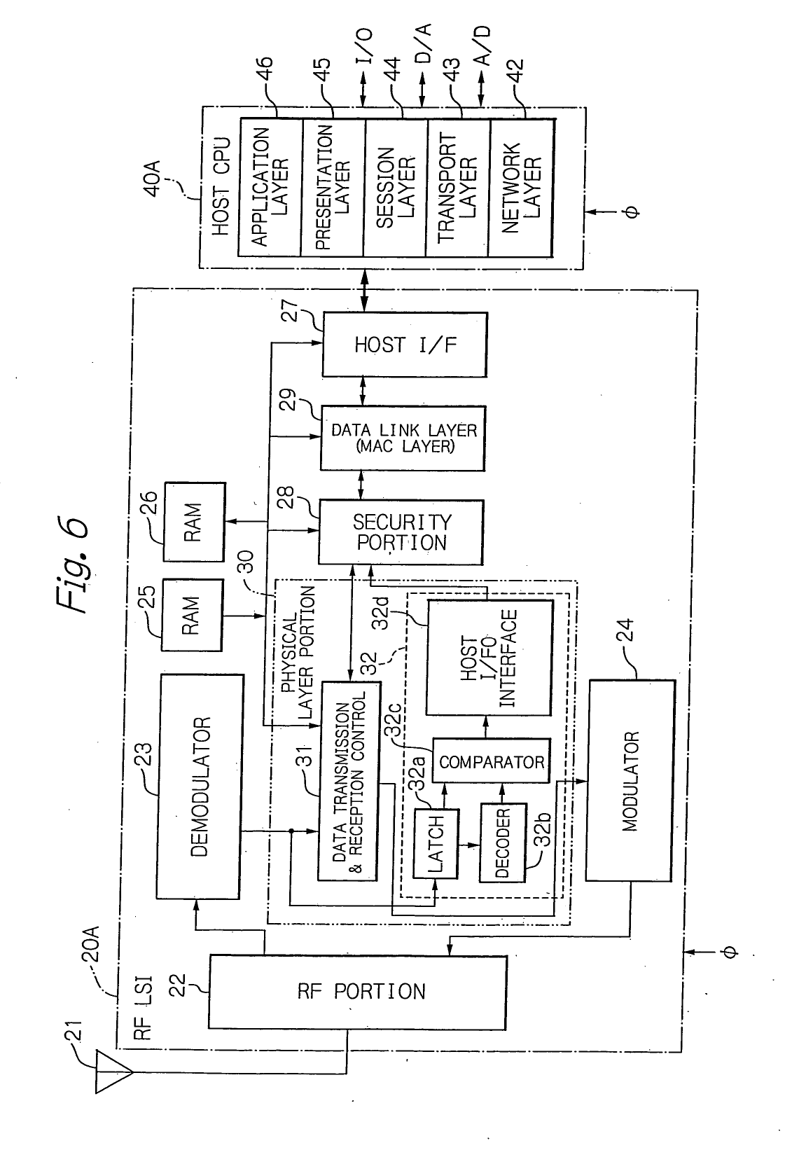

FIG. 6 is a functional block diagram of the radio frequency LSI in an alternative embodiment according to the present invention. In the following, like elements are denoted with the same reference numerals. The alternative embodiment may be the same as the illustrative embodiment shown in described with reference to FIG. 1 except that the host CPU 40A does not include a data link layer with the MAC layer corresponding to the data link layer 41 but instead the radio frequency LSI 20A includes a data link layer 29 having the MAC layer together with a security portion (AES) 28.

The security portion 28 and data link layer 29 are connected between the physical layer portion 30 and host interface 27 as illustrated. To the security portion 28 and data link layer 29, the RAMs 25 and 26 are connected. The security portion 28 comprises a security function, such as a concealment function, a certification function, defined by IEEE 802.15.4. The security portion 28 has, for example, a block of data having 128 bits with a key length fixed to 128 bits. As with the data link layer 41 shown in FIG. 1, the data link layer 29 comprises the MAC layer, which is the data format process layer. Some of the functions of the MAC layer are removed, such as the latch of the data necessary for determining the transfer mode (through mode/security mode) and the transmission of the data to the MAC layer. Those removed functions are provided in the physical layer portion 30.

If no security data exist in the single bit position “Security enabled” at the third bit of the field, Frame Control, FIG. 3, of the data receiving format shown in FIG. 2, the transfer mode is then rendered the through mode, providing the same operation as in the embodiment shown in FIG. 1. If the security data exist, the transfer mode is then rendered the security mode, thereby permitting the security function to be performed during transmission and reception.

In the alternative embodiment, the radio frequency LSI 20A comprises the MAC layer so that the radio frequency LSI 20A can perform the complicated MAC process thereinside, thereby making it possible to implement and control the ZigBee network be means of the host CPU 40A with lower performance, such as an 8-bit processor. Furthermore, the radio frequency LSI 20A with the built-in MAC layer comprises the physical layer portion 30, and at the second time point at which data necessary for determining the received data transfer mode refixed in the physical layer portion 30, the physical layer portion 30 latches the data and notifies the MAC layer, so that the burden incurred on the MAC layer can be decreased and the MAC can be notified more rapidly of information on the field, Addressing Field, thereby improving the performance of the series of the data transfer process.

The present invention is not limited to the above described embodiments, but is susceptible to various modifications. For example, the physical layer portion 30 in the embodiment shown in FIG. 1 is applicable to various circuits which are adapted to allow the physical layer to latch data necessary for determining the received data transfer mode and to notify the MAC layer. Therefore, for example, a one-chip radio frequency LSI with the host CPU 40A, FIG. 6, built in the radio frequency LSI 20A may attain the same operational advantages.

In addition, because the circuit configurations of the radio frequency LSIs 20 and 20A and the host CPUs 40 and 40A shown in and described with reference to FIGS. 1 and 6 are merely exemplary, these circuits 20, 20A, 40, and 40A may comprise various additional circuits such as a timer, reset function, and clock control function.

The entire disclosure of Japanese patent application No. 2005-000904 filed on Jan. 5, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What I claim is:

1. A radio frequency integrated circuit for transmitting and receiving data over a radio wave according to a radio frequency communication standard regulating a physical layer which controls transmission or reception of data, a data link layer including a media access control layer which analyzes data to be transmitted or data received and controlled by the physical layer to determine a transfer mode and which uses the transfer mode determined to process the data to be transmitted or data received to transfer the data processed to a next layer, and a network layer which manages a transfer of the data to be transmitted or data received and transferred from the data link layer,
said radio frequency integrated circuit comprising:
a radio frequency transmitter/receiver for receiving an incoming radio wave to output the received data, and for converting the data to be transmitted to an outgoing radio wave to transmit the outgoing radio wave;
a demodulator for demodulating the received data into a symbol to output symbol data received;
a physical layer portion;
said physical layer portion comprising,
a data transmission and reception control for converting, during reception, the symbol data received into byte data received, and outputting, during transmission, symbol data to be transmitted, and
a transfer mode determination portion for determining, at a first time point at which first identification data in the received data necessary for determining a received data transfer mode are fixed, a data length of subsequent second identification data, and latching, at a second time point at which data corresponding to the data length determined of the second identification data are fixed, data necessary for determining the received data transfer mode to transfer the data to the media access control layer; and
a modulator for modulating the symbol data to be transmitted into the data to be transmitted to output the data to be transmitted to the radio frequency transmitter/receiver.

2. The integrated circuit according to claim 1, comprising a function of the data link layer having the media access control layer.

3. The integrated circuit according to claim 1, comprising a function regulated by the radio frequency communication standard.

4. The integrated circuit according to claim 1, wherein the radio frequency communication standard is ZigBee.
